(19) United States
(12) Patent Application Publication
(10) Pub. No.: US 2010/0044467 A1
(43) Pub. Date: Feb. 25, 2010

(54) Portable sun care sprayer

(76) Inventor: Kent McGuire, Conway, SC (US)

Correspondence Address: GUERRY LEONARD GRUNE, 784 S VILLIER CT., VIRGINIA BEACH, VA, 23452, US

(21) Appl. No.: 12/229,488

(22) Filed: Aug. 22, 2008

(51) Int. Cl. B05B 15/00

(52) U.S. Cl. 239/289

(57) ABSTRACT

The objective of the device is to spray sun care products out of a hand sprayer and can be moved from customer to customer.

### BACKGROUND

The present invention relates to a portable sun care sprayer that sprays sun care products out of a hand sprayer and can be moved from customer to customer.

### SUMMARY

The device is comprised of the following components and steps:
Insert money in a credit or cash machine this initializes the session.
The sun care product or products are then run through a pump to a hand sprayer or wand and can be sprayed on to the customer.

The device sprays the body with a sun care or product with a certain purpose of reacting with the skin.

### BRIEF DESCRIPTION OF THE DRAWING

FIG. 1 is a perspective view of a portable sun care sprayer and man using the device.

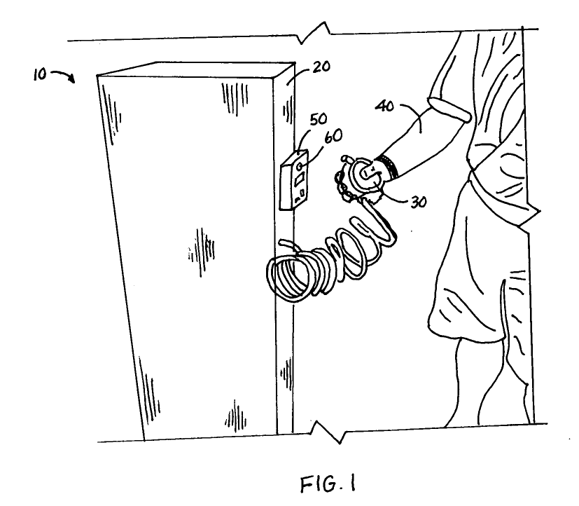

10 is a portable sun care sprayer.

20 is an aluminum box in which pump and sun care products are kept.

30 is a spray wand.

40 is a man.

50 is a vending unit with a controller which controls times and transaction reports.

60 is a start button.

What is claimed is:

1. A portable sun care sprayer comprising: a pump to a hand sprayer for spraying sun care products initialized with a credit or cash machine.
